(19) United States
(12) Patent Application Publication
(10) Pub. No.: US 2004/0186607 A1
(43) Pub. Date: Sep. 23, 2004

(54) Display device and history collecting system

(75) Inventors: Akira Yoshinaga, Numazu-shi (JP); Jun Koike, Shizuoka-ken (JP); Fumiyuki Katoh, Shizuoka-ken (JP); Makoto Nishizawa, Numazu-shi (JP)

Correspondence Address: PILLSBURY WINTHROP, LLP, P.O. BOX 10500, MCLEAN, VA, 22102, US

(73) Assignee: TOSHIBA MACHINE CO., LTD., Tokyo (JP)

(21) Appl. No.: 10/766,472

(22) Filed: Jan. 29, 2004

(30) Foreign Application Priority Data
Jan. 30, 2003 (JP) 2003-022520
Jan. 8, 2004 (JP) 2004-003068

(51) Int. Cl. G06F 19/00

(52) U.S. Cl. 700/109; 702/187

(57) ABSTRACT

A display device of an industrial machine that operates in accordance with an operating condition according to an aspect of the invention includes a unit which inputs a state of an operating quality for a change in the operating condition, a unit which stores history data indicative of the change in the operating condition and the state of the operating quality corresponding to the change, and a unit which displays the history data.

### CROSS-REFERENCE TO RELATED APPLICATIONS

This application is based upon and claims the benefit of priority from the prior Japanese Patent Applications No. 2003-022520, filed Jan. 30, 2003; and No. 2004-003068, filed Jan. 8, 2004, the entire contents of both of which are incorporated herein by reference.

### BACKGROUND OF THE INVENTION

1. Field of the Invention

The present invention relates to a display device of an industrial machine and a history collecting system.

2. Description of the Related Art

The display area of the display device of an injection molding machine is generally limited. Jpn. Pat. Appln. KOKAI Publication No. 2001-145947 discloses a prior art display device for an injection molding machine, which displays pieces of information almost simultaneously on both the main screen region and the sub-screen region.

On this display device, the main screen region is not hidden even when the sub-screen region is displayed.

The main screen region and sub-screen region can freely be displayed in combination with each other.

A user can display necessary information without any cumbersome operation to efficiently set molding conditions of the injection molding machine and check operating qualities thereof and the like.

The above prior art display device can display both molding conditions that have not been changed and molding conditions that have been changed, as shown in FIG. 1.

It is however difficult for the user of the injection molding machine to evaluate the injection molding machine after the molding conditions are changed, e.g., to understand the quality of a product even though the user checks the molding conditions before and after they are changed.

The user therefore needs to take notes of the evaluation of the injection molding machine when he or she operates the injection molding machine after the molding conditions are changed.

If the user takes no notes, a phenomenon caused by the injection molding machine after the molding conditions are changed becomes unclear. The user therefore needs to check, e.g., the quality of a product again under the same molding conditions. It is thus difficult for the user to perform an efficient operation.

### BRIEF SUMMARY OF THE INVENTION

Aspects of the present invention have been developed in consideration of the above situation. An object of the aspects is to provide a display device of an industrial machine capable of easily understanding the operating quality of the machine whose operating conditions are changed.

According to the first aspect of the present invention, there is provided a display device of an industrial machine that operates in accordance with an operating condition. The display device comprises a unit which inputs a state of an operating quality for a change in the operating condition, a storage process unit which stores history data indicative of the change in the operating condition and the state of the operating quality corresponding to the change, and a unit which displays the history data.

According to the second aspect of the present invention, there is provided a history collecting system. The history collecting system comprises a communication unit which gains access to a display device of an industrial machine operated in accordance with an operating condition through a communication medium, a unit which reads history data indicative of a change in the operating condition and a state of an operating quality corresponding to the change in the operating condition from the display device using the communication unit, and a unit which stores the history data.

### BRIEF DESCRIPTION OF THE SEVERAL VIEWS OF THE DRAWING

FIG. 1 is a chart showing an example of prior art history display of operating conditions;

FIG. 2 is a block diagram showing an example of a display device of an industrial machine according to a first embodiment of the present invention;

FIG. 3 is a front view showing an example of the display device according to the first embodiment;

FIG. 4 is an illustration of a maintenance screen of the display device according to the first embodiment;

FIG. 5 is an illustration of a history screen of the display device according to the first embodiment;

FIG. 6 is an illustration of a quality setting screen of the display device according to the first embodiment;

FIG. 7 is an illustration of the history screen after a condition and a quality are set;

FIG. 8 is a flowchart of the first half of a process of displaying the condition and quality by the display device according to the first embodiment;

FIG. 9 is a flowchart of the second half of the process of displaying the condition and quality by the display device according to the first embodiment; and

FIG. 10 is a block diagram showing an example of a history collecting system according to a second embodiment of the present invention.

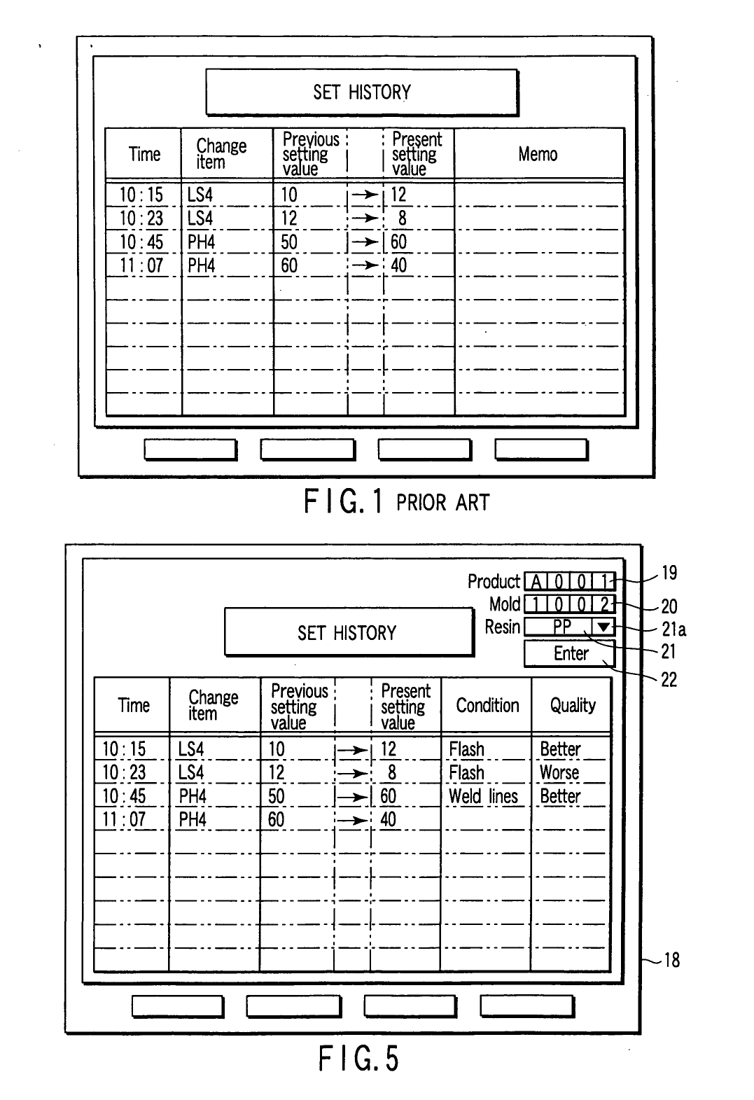

### DETAILED DESCRIPTION OF THE INVENTION

Preferred embodiments of the present invention will be described below with reference to the several views of the accompanying drawings.

(First Embodiment)

The first embodiment is directed to a display device of an industrial machine which stores both history data indicative of changes in setting of operating conditions of the industrial machine and operating quality corresponding to the changes in setting and which displays the stored the history data.

The first embodiment will exemplify an injection molding machine as an industrial machine. The industrial machine is not limited to the injection molding machine, but may be other machines such as an injection molding machine, an extruder, a machine tool, a die casting machine, a robot, a semiconductor manufacturing device, and a printing device.

The first embodiment will also exemplify molding conditions as the operating conditions of the industrial machine. The operating conditions are not limited to the molding conditions, but may be other conditions.

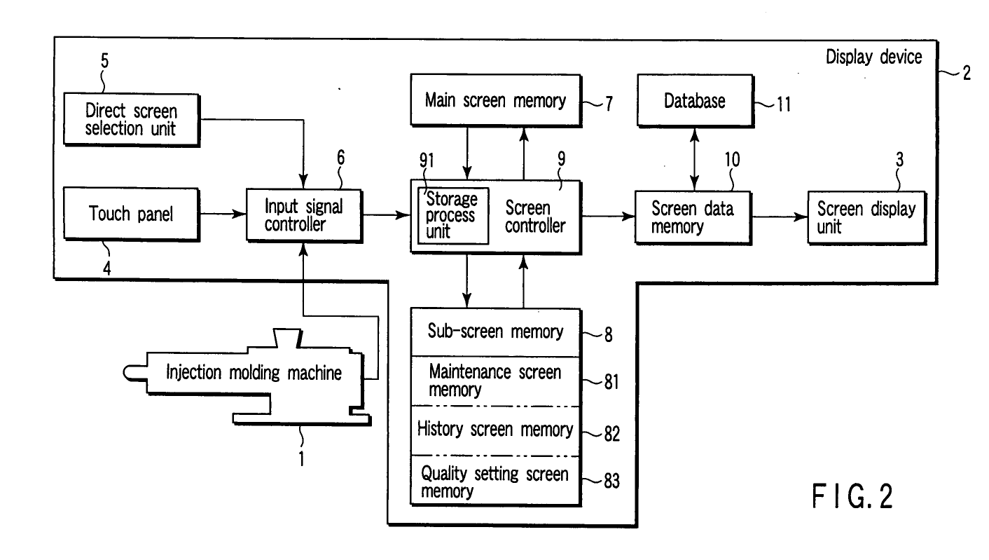

FIG. 2 is a block diagram showing an example of a display device of an industrial machine according to the first embodiment.

FIG. 2 shows a display device 2 of an injection molding machine 1. The display device 2 comprises a screen display unit 3, a touch panel 4, a direct screen selection unit 5, an input signal controller 6, a main screen memory 7, a sub-screen memory 8, a screen controller 9, a screen data memory (e.g., a VRAM) 10, and a database 11.

The screen display unit 3 is mounted on a surface area of the display device 2. The unit 3 is formed of, e.g., a liquid crystal panel. The unit 3 displays the contents of screen data stored in the screen data memory 10.

The touch panel 4 is transparent and is attached to the screen display unit 3.

The direct screen selection unit 5 is mounted on a surface area of the display device 2. The unit 5 includes push button switches corresponding to various screens to receive instructions to display various screens from a user.

The input signal controller 6 receives a signal from the touch panel 4, a signal from the direct screen selection unit 5, and various signals from the injection molding machine 1. The controller 6 outputs these signals to the screen controller 9.

The main screen memory 7 stores main screen data.

The sub-screen memory 8 stores sub-screen data.

The screen controller 9 receives a display request signal of an arbitrary screen via the input signal controller 6 and reads main screen data from the main screen memory 7 and sub-screen data from the sub-screen memory 8.

The screen controller 9 creates screen data based on the main screen data and sub-screen data and stores the screen data in the screen data memory 10. The screen data stored in the screen data memory 10 is displayed by the screen display unit 3.

The screen controller 9 includes a storage process unit 91.

The storage process unit 91 receives the changed molding conditions of the injection molding machine 1 through the input signal controller 6.

The storage process unit 91 receives the molding qualities corresponding to the changed molding conditions through the input signal controller 6.

The storage process unit 91 also receives product identification data indicative of a product, which is manufactured by the injection molding machine 1 in accordance with the changed molding conditions, through the input signal controller 6.

The storage process unit 91 stores the product identification data to history data indicative of the changed molding conditions and the molding qualities corresponding to the conditions, and stores the resultant data in the sub-screen memory 8.

The screen controller 9 receives a history data display request signal via the input signal controller 6, and creates sub-screen data using the history data and product identification data stored in the sub-screen memory 8 and stores the sub-screen data in the screen data memory 10. Thus, the screen display unit 3 displays the contents of the history data and product identification data.

For example, the screen controller 9 reads history data corresponding to the product identification data designated through the input signal controller 6 and creates history screen data including the read history data.

The database 11 is connected to the screen data memory 10. Thus, the database 11 can store history data including a setting history of the molding conditions and states of the molding qualities as well as the product identification data.

The product identification data stored in the database 11 together with the history data includes data of product numbers, mold numbers, resin materials and product molding conditions. Both the history data and product identification data can be used as AI molding assisted data outside or inside the screen data memory 10.

When the database 11 manages both the history data and product identification data, the database 11 can be used as AI molding assisted software.

The AI molding assisted data or AI molding assisted software is used to assist the setting of molding conditions and capable of allowing a user to easily input the molding conditions even though the user does not have much experience of molding.

The AI molding assisted software holds data of resin materials and the size and thickness of a molding product in advance. When a defective mold is produced, the AI molding assisted software receives molding data of the defective mold and determines what value of temperature, injection speed, or the like are appropriate. When the AI molding assisted software determines that the value is not appropriate, the AI molding assisted software outputs a direction in which the value is changed (level of the value).

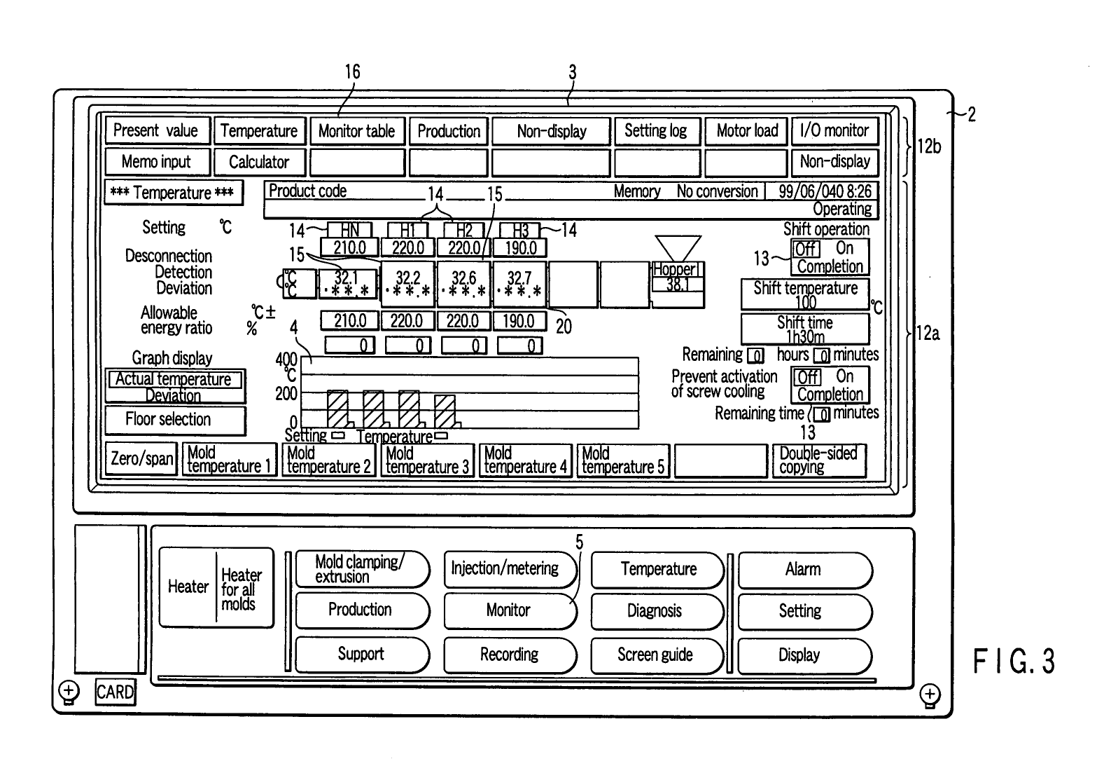

FIG. 3 is a front view showing an example of the display device 2 according to the first embodiment.

The screen display unit 3 of the display device 2 is used as a human interface.

The screen of the screen display unit 3 is divided into two screens. One of the two screens is a main screen region 12a and the other screen is a sub-screen region 12b.

The main screen region 12a includes a controller function switch 13 capable of performing the controller function of the injection molding machine 1 and a setting device 14 capable of setting the molding conditions of the injection molding machine 1. A touch panel 4 is used for each of the controller function switch 13 and the setting device 14.

The main screen region 12a also includes a monitoring data display 15 for displaying monitoring data.

The sub-screen region 12b displays various data items of monitoring data such as the present and past values, which are to be displayed any time irrespective of the main screen region 12a.

The direct screen selection unit 5 comprises a mold clamping/extrusion button, an injection/metering button, a temperature button, a production button, a monitor button, a diagnosis button, a support button, a recording button, a screen guide button, an alarm button, a setting button, and a display button. When a button of the direct screen selection unit 5 is touched, a screen corresponding to the touched button is displayed in the main screen region 12a. The direct screen selection unit 5 can be located within the main screen region 12a.

In FIG. 3, the main screen region 12a displays a screen of temperature.

The touch panel 4 is attached to the entire sub-screen region 12b. The sub-screen region 12b includes a sub-screen selection unit 16. The sub-screen selection unit 16 comprises a current value button, a temperature button, a monitor table button, a production button, and a non-display button.

When the current value button is touched, the sub-screen region 12b displays the current state of the injection molding machine 1 including injection time, cooling time, medium time, a screw position, a die plate position, an extrusion position, injection pressure/back pressure, clamping force, and screw speed.

After the current state of the injection molding machine 1 is displayed, an arbitrary position in the sub-screen region 12b is touched, and then the sub-screen region 12b displays again the sub-screen selection unit 16 shown in FIG. 3.

When the temperature button of the sub-screen selection unit 16 is touched, the sub-screen region 12b displays both a temperature corresponding to the position of a hopper and a temperature deviation.

When the monitor table button of the sub-screen selection unit 16 is touched, the sub-screen region 12b displays filling time corresponding to a shot number, metering time, stripping time, cycle time, minimum cushion, dwell switching, injection start, and screw speed.

When the production button of the sub-screen selection unit 16 is touched, the sub-screen display region 12b displays the current number of shots, the number of non-defective shots out of the current number of shots, the remaining number of shots, the total number of products, the number of non-defectives, the number of defectives, the remaining number of products, the working ratio, the lot achievement ratio, the fraction defective, and the remaining production time.

When the non-display button of the sub-screen selection unit 16 is touched, a non-display screen appears.

The display contents of the main screen region 12a can be switched by touching a button of the direct screen selection unit 5. The display contents of the sub-screen region 12b can be switched by touching a button of the sub-screen selection unit 16.

There now follows an explanation as to the sub-screen memory 8.

The sub-screen memory 8 includes a maintenance screen memory 81, a history screen memory 82 and a quality setting screen memory 83.

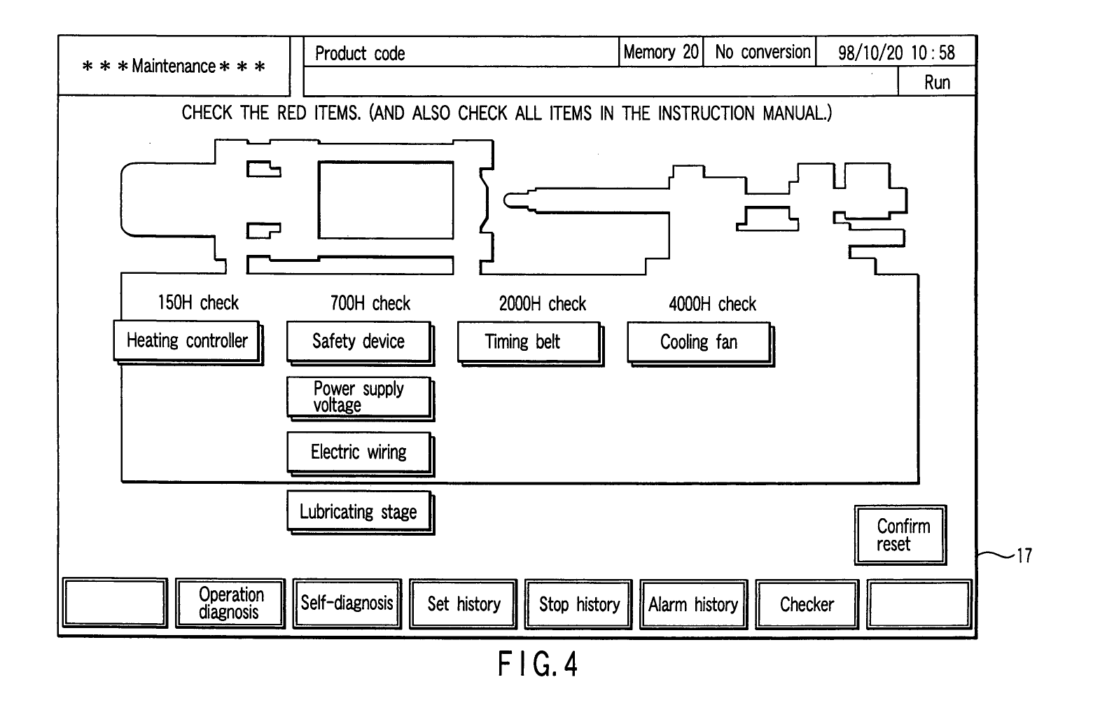

FIG. 4 shows an example of the maintenance screen 17.

Setting buttons such as an operation diagnostic button, a self-diagnostic button, a setting history button, a stop history button, an alarm history button and a checker button are arranged in the lower part of the maintenance screen 17. The touch of these buttons is sensed by the touch panel 4.

The other part of the maintenance screen 17 displays, for example, check items such as “Heating Controller,” “Safety Device,” “Power Supply Voltage,” “Electric Wiring,” “Lubricating State” and “Timing Belt” and given time checks of each of the check items.

The maintenance screen memory 81 stores maintenance screen data for displaying the maintenance screen 17.

The maintenance screen 17 is displayed in the main screen region 12a when the diagnosis button of the direct screen selection unit 5 shown in FIG. 3 is touched.

FIG. 5 shows a history screen 18 as an example.

The history screen 18 displays a relationship between a history of changes in molding conditions, molding qualities and product identification data.

The history screen 18 also displays items of “Time,” “Change item,” “Previous setting value (previous value of molding condition),” “Present setting value (Present value of molding condition),” “Condition (molding condition)” and “Quality (state of molding product quality).”

The history screen data for displaying the history screen 18 includes history data. The history screen data is stored in the history screen memory 82. The touch of buttons on the history screen 18 is sensed by the touch panel 4.

The history screen 18 is displayed in the main screen region 12a when a user touches, for example, the setting history button in the lower part of the maintenance screen shown in FIG. 3.

First, the history screen 18 displays the most recently displayed setting contents.

The user inputs the product number of a product that needs to change in molding conditions, the mold number of the product, and product identification data including data indicative of resin materials of the product.

A product number input unit 19, a mold number input unit 20, a resin material input unit 21 and an enter button 22 are arranged at the upper right of the history screen 18.

When the user touches the product number input unit 19, a window for inputting alphanumeric characters is displayed. The user designates the alphanumeric characters and inputs the product number.

When the user touches the mold number input unit 20, a window for inputting alphanumeric characters is displayed. The user designates the alphanumeric characters and inputs the mold number.

When the user touches a down arrow 21a of the resin material input unit 21, a resin material list window is displayed. The user designates a targeted resin material from the list and inputs the targeted resin material.

The user inputs the product number, mold number and resin number to the product number input unit 19, mold number input unit 20 and resin material input unit 21, respectively and touches the enter button 22.

Then, the screen controller 9 reads history data corresponding to the designated product identification data from the history screen memory 82 and creates history screen data including the read history data. Thus, the designated history data is displayed on the history screen 18.

In the history screen 18 shown in FIG. 5, the user can confirm that the state of condition “Flash” is quality “Better” when item “LS4” is changed from “10” to “12” at time “10:15.”

The user can also confirm the quality after the molding conditions are changed at time “10:23” and time “10:45.”

At time “11:07,” item “LS4” is changed from “10” to “12;” however, both condition and quality are undesignated and thus their fields are blank.

The user touches one of the blank fields in order to designate the condition and quality.

Then, the screen controller 9 receives a request signal for setting the condition and quality through the touch panel 4 and input signal controller 6, reads quality setting screen data from the quality setting screen memory 83 and supplies the quality setting screen data to the screen data memory 10. The quality setting screen is displayed accordingly.

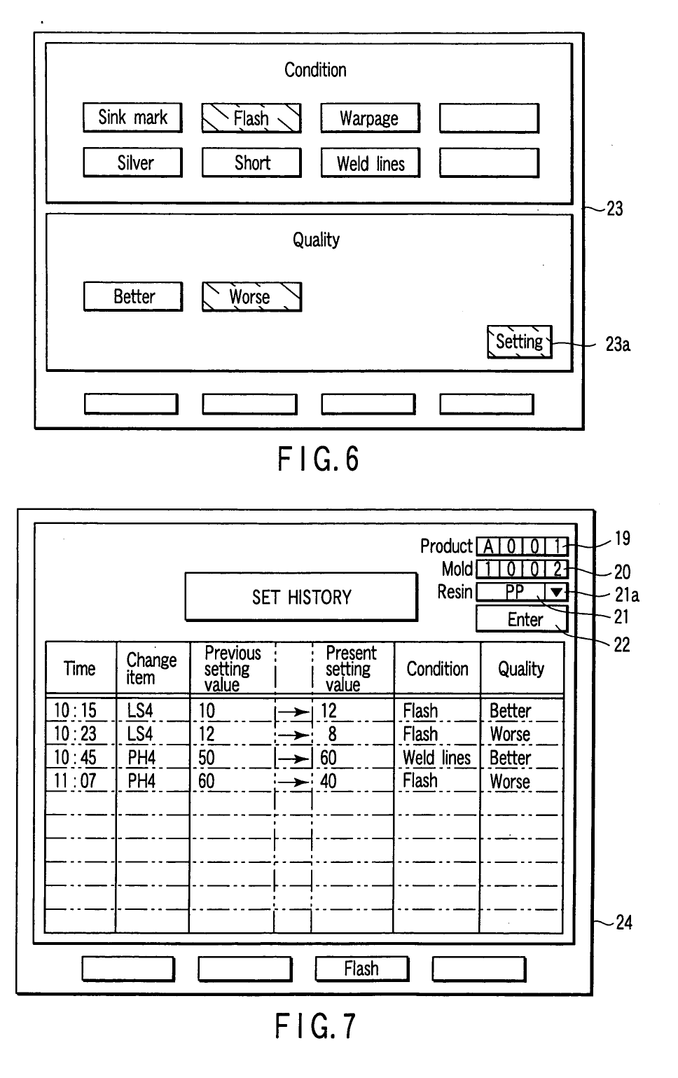

FIG. 6 shows a quality setting screen 23 as an example.

The quality setting screen 23 sets both the condition and quality. As the condition, the screen 23 displays “Sink Mark,” “Flash,” “Warpage,” “Silver,” “Short,” and “Weld Lines.”

As the quality, the screen 23 displays “Better” and “Worse.”

The screen 23 also displays a set button 23a that is touched when the setting of the condition and quality is completed.

A user designates the condition and quality and touches the set button 23a.

Then, the storage process unit 91 of the screen controller 9 supplies the user-designated condition and quality through the touch panel 4 and input signal controller 6 and stores history data, which indicates that the state of condition “Flash” is quality “Better” for a change in molding condition at time “11:07,” in the history screen memory 82.

When the user touches the set button 23a of the quality setting screen 23, the screen switches from the quality setting screen 23 to the history screen to which the set contents are added.

FIG. 7 shows as an example a history screen 24 appearing after the condition and quality are set in the history screen 18 shown in FIG. 5.

The history screen 24 displays condition “Flash” and quality “Worse” for a change in molding condition at time “11:07.”

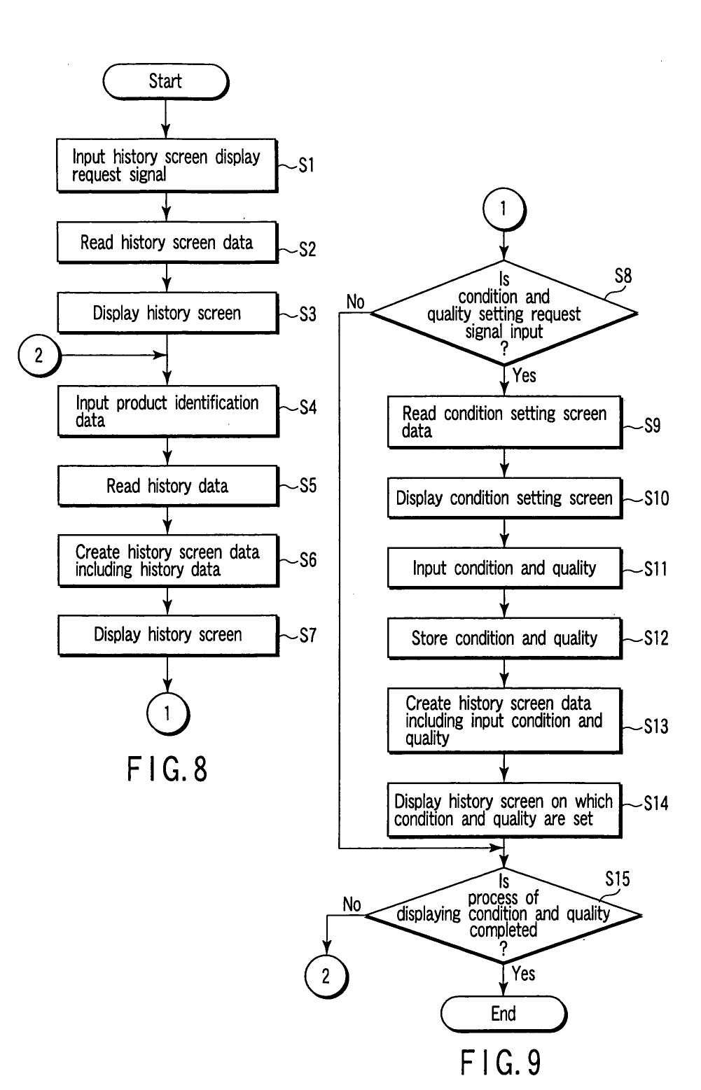

FIG. 8 is a flowchart of the first half of a process of displaying the condition and quality by the display device 2.

FIG. 9 is a flowchart of the second half of the process thereof.

In step S1, the screen controller 9 inputs a history screen display request signal via the touch panel 4 and input signal controller 6.

In step S2, the screen controller 9 reads history screen data from the history screen memory 82 and stores the history screen data in the screen data memory 10 in order to make a user input product identification data.

In step S3, the screen display unit 3 displays a history screen based on the history screen data stored in the screen data memory 10.

In step S4, the screen controller 9 inputs the product identification data designated by the user through the touch panel 4 and input signal controller 6.

In step S5, the screen controller 9 reads the history data corresponding to the input product identification data from the history screen memory 82.

In step S6, the screen controller 9 creates history screen data including the read history data and stores the history screen data in the screen data memory 10.

In step S7, the screen display unit 3 displays a history screen based on the history screen data stored in the screen data memory 10.

In step S8, the screen controller 9 determines whether a condition and quality setting request signal is input through the touch panel 4 and input signal controller 6.

If the request signal is not input, the process moves to step S15.

If the request signal is input, in step S9, the screen controller 9 reads quality setting screen data from the quality setting screen memory 83 and stores the quality setting screen data in the screen data memory 10.

In step S10, the screen display unit 3 displays a quality setting screen based on the quality setting screen data stored in the screen data memory 10.

In step S11, the screen controller 9 inputs the condition and quality designated by the user through the touch panel 4 and input signal controller 6.

In step S12, the screen controller 9 stores the input condition and quality in the history screen memory 82.

In step S13, the screen controller 9 creates history screen data including the input condition and quality and stores the history screen data in the screen data memory 10.

In step S14, the screen display unit 9 displays the history screen on which the condition and quality are set, based on the history screen data stored in the screen data memory 10.

The step S12 may be executed after the step S13 or step S14.

The step S12 may also be executed in parallel with the step S13 or step S14.

In step S15, the screen controller 9 determines whether a condition and quality display end signal is input through the touch panel 4 and input signal controller 6.

If the end signal is not input, the process moves to step S4.

If the end signal is input, the process ends.

In the first embodiment described above, a relationship between molding condition and molding quality is displayed. Thus, a user can easily and quickly understand the relationship and efficiently make an operation without doing any molding try again.

Since the user can easily understand the above relationship, time required for making a molding try can be shortened. Thus, time required for obtained a non-defective mold can be shortened and the number of defective molds can be reduced, thereby lowering manufacturing costs.

In the first embodiment, the input and storage of molding condition and molding quality for the history of setting of molding are selected from items displayed on the screen and performed only by touching buttons.

Consequently, the user can easily input and store the molding condition and molding quality for the history of setting of molding.

There is a case where a computer is used as the above display device 2 of an industrial machine. In this case, the computer performs the operations described above.

(Second Embodiment)

The second embodiment is directed to a history collecting system for collecting history data and product identification data, which has been described in the above first embodiment, through a communication medium.

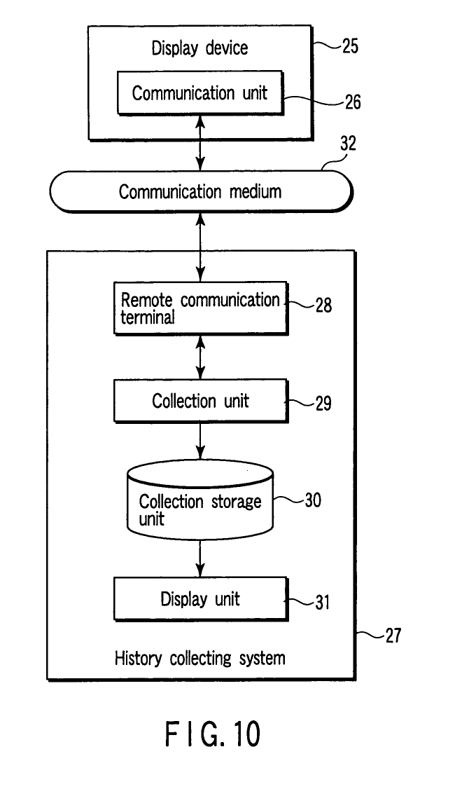

FIG. 10 is a block diagram of a history collecting system 27 according to the second embodiment of the present invention.

FIG. 10 shows a display device 25 of an injection molding machine 1. The display device 25 includes a communication unit 26 as well as substantially the same components as those of the display device 2 according to the first embodiment. The components of the display device other than the communication unit 26 are omitted from FIG. 10.

The history collecting system 27 includes a remote communication terminal 28, a collection unit 29, a collection storage unit 30 and a display unit 31. The history collecting system 27 is located away from the display device 25 through a communication medium 32 such as the Internet.

The remote communication terminal 28 gains access to the display device 25 through the communication medium 32 to perform communications between the display device 25 and communication unit 26. The collection unit 29 reads both history data and product identification data from a sub-screen memory 8 or a database 11 via the communication medium 32 and the communication unit 26 of the display device 25.

The collection storage unit 30 stores both the history data and product identification data read by the collection unit 29. For example, the history collecting system 27 stores the history data and product identification data in a database.

The display unit 31 displays both the history data and product identification data stored in the collection storage unit 30.

In the foregoing first and second embodiments, the respective components can freely be modified if the same operation can be performed. For example, the components can be changed in arrangement, freely combined with each other, or freely separated from each other.

For example, the display devices 1 and 25 each have a controller that is made up of a combination of the screen controller 9 and screen data memory 10.

In the above embodiments, the functions of the input signal controller 6, screen controller 9, remote communication terminal 28 and collection unit 29 can be fulfilled by a computer equipped with programs.

In this case, the programs are written to a recording medium such as a magnetic disk (e.g., a flexible disk and a hard disk), an optical disk (e.g., a CD-ROM and a DVD), and a semiconductor memory. Furthermore, the programs can be transmitted through a communication medium.

A computer reads the programs and its operation is controlled by the programs, thereby fulfilling the functions of the input signal controller 6, screen controller 9, remote communication terminal 28 and collection unit 29.

What is claimed is:

1. A display device of an industrial machine that operates in accordance with an operating condition, the display device comprising:
a unit which inputs a state of an operating quality for a change in the operating condition;
a storage process unit which stores history data indicative of the change in the operating condition and the state of the operating quality corresponding to the change; and
a unit which displays the history data.

2. The display device according to claim 1, wherein the storage process unit records data indicative of product identification data indicating a product produced by the industrial machine in accordance with the change in the operating condition and the history data corresponding to the product identification data.

3. The display device according to claim 1, wherein the history data and the product identification data are used for assisted software for assisting an operating condition setting operation.

4. A history collecting system comprising:
a communication unit which gains access to a display device of an industrial machine operated in accordance with an operating condition through a communication medium;
a unit which reads history data indicative of a change in the operating condition and a state of an operating quality corresponding to the change in the operating condition from the display device using the communication unit; and
a unit which stores the history data.
